(19) United States
(12) Patent Application Publication
(10) Pub. No.: US 2025/0385727 A1
(43) Pub. Date: Dec. 18, 2025

(54) BEAM STEERING FOR RELAY AIRCRAFTS

(71) Applicant: QUALCOMM Incorporated, San Diego, CA (US)

(72) Inventors: Mingxi YIN, Beijing (CN); Kangqi LIU, San Diego, CA (US); Qiaoyu LI, Beijing (CN); Chao WEI, Beijing (CN); Ruiming ZHENG, Beijing (CN); Hao XU, Beijing (CN)

(21) Appl. No.: 18/880,181

(22) PCT Filed: Aug. 12, 2022
(86) PCT No.: PCT/CN2022/112018

§ 371 Date: Dec. 30, 2024

(51) Int. Cl. H04B 7/185; H04B 7/0426

(52) U.S. Cl. CPC H04B 7/18504; H04B 7/043

(57) ABSTRACT

Systems and techniques are provided for performing wireless communication. In some aspects, an aircraft user equipment (UE) may determine an aerial zone based on a location of the aircraft UE. The aircraft UE may determine a mapping of the aerial zone to at least one terrestrial zone and steer a radio frequency (RF) beam to a position within the at least one terrestrial zone. In some examples, determining the mapping comprises transmitting, to a network entity, an aerial zone identifier corresponding to the aerial zone and receiving, from the network entity, a terrestrial zone identifier corresponding to the at least one terrestrial zone.

### CROSS-REFERENCE TO RELATED APPLICATIONS

This application for patent is a 371 of international Patent Application PCT/CN2022/112018, filed Aug. 12, 2022, which is hereby incorporated by referenced in its entirety and for all purposes.

### FIELD OF THE DISCLOSURE

Aspects of the present disclosure generally relate to wireless communication. In some implementations, examples are described for performing wireless communications using air-to-ground (ATG) connections.

### BACKGROUND OF THE DISCLOSURE

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

Air-to-ground (ATG) communications systems are deployed to provide various telecommunication services associated with aircrafts. ATG communications systems can be implemented to interface with terrestrial wireless communications systems by positioning terrestrial antennas (e.g., at a base station) in a manner that can communicate with aircraft antennas while the aircraft is in flight. In some cases, ATG communications can be used to provide in-flight communication services for airborne devices. In addition, ATG communications can be used to provide airline operations communications (e.g., aircraft maintenance, flight planning, weather, etc.) as well as air traffic control information.

### SUMMARY

Air-to-ground (ATG) communications can be used to provide connectivity between terrestrial wireless communication networks and aircrafts. In some cases, an aircraft can be configured as a relay aircraft that can relay data between a user equipment (UE) and a network entity (e.g., a base station). In some cases, a given aircraft may only be able to serve as a relay aircraft for a short time due to the speed of flight of the aircraft through a relay area in which the aircraft is able to communicate with the UE and the base station (e.g., intersection between the flight route and coverage areas of the UE and/or the base station). The limited time that an aircraft may perform as a relay aircraft may not be sufficient for performing various ATG communications. For example, a UE may not receive feedback to an SOS message within the short window of time that the relay aircraft remains within range of both the UE and the base station to which the UE's SOS message is relayed by the relay aircraft.

In some examples, multiple relay aircraft may be within ATG communication range with a remote UE (e.g., within LoS propagation distance). In such examples, multiple relay aircraft may be able to provide ATG communication coverage to the same out of coverage terrestrial or surface location (e.g., multiple relay aircraft may be able to provide ATG communication coverage to the same remote UE). With multiple relay aircrafts, ATG communication path switching and/or relay aircraft handover may occur frequently. Also, such a scenario for ATG communications between multiple relay aircraft and a remote UE may be associated with a large computational overhead. Further, in some examples, such a multiple (or “dense”) aircraft scenario can be associated with interference between ATG communications transmitted from the different relay aircraft to the same remote UE, which can impede or prevent successful transmission of SOS or other messages by the remote UE.

There is a need for systems and techniques that can be used to perform ATG communications between a remote UE and relay aircrafts in a dense aircraft scenario, with reduced switching and/or handover of relay aircraft and with an improved service time of each relay aircraft beam for a given out-of-coverage zone (e.g., the location of the remote UE).

In some aspects, systems and techniques are described for performing wireless communication. For example, the systems and techniques can be used to perform beam steering for one or more relay aircrafts in an air-to-ground (ATG) communications network. For instance, the one or more relay aircraft may be used to perform ATG communication with a remote user equipment (UE). The remote UE is located outside of the coverage area associated with a wireless communication network and the one or more relay aircrafts may be used to relay a message from the remote UE to a base station included in the wireless communication network. In some cases, the systems and techniques can be used to perform beam steering for the one or more relay aircrafts to reduce the incidence of the remote UE switching ATG communication paths between different relay aircrafts and/or to reduce the incidence of handovers between different relay aircrafts. In one illustrative example, the systems and techniques can be used to perform beam steering based on a three-dimensional (3D) zone identifier associated with the current location of a relay aircraft and a two-dimensional (2D) zone identifier associated with a terrestrial surface location of the remote UE.

According to at least one illustrative example, a method of wireless communications performed at an aircraft user equipment (UE) is provided. The method includes: determining an aerial zone based on a location of the aircraft UE; determining a mapping of the aerial zone to at least one terrestrial zone; and steering a radio frequency (RF) beam to a position within the at least one terrestrial zone.

In another example, an apparatus for wireless communications performed at an aircraft user equipment (UE) is provided that includes at least one memory (e.g., configured to store data) and at least one processor (e.g., implemented in circuitry) coupled to the at least one memory. The at least one processor is configured to and can: determine an aerial zone based on a location of the aircraft UE; determine a mapping of the aerial zone to at least one terrestrial zone; and steer a radio frequency (RF) beam to a position within the at least one terrestrial zone.

In another example, a non-transitory computer-readable medium is provided that has stored thereon instructions that, when executed by one or more processors, cause the one or more processors to: determine an aerial zone based on a location of the aircraft UE; determine a mapping of the aerial zone to at least one terrestrial zone; and steer a radio frequency (RF) beam to a position within the at least one terrestrial zone.

In another example, an apparatus for wireless communications performed at an aircraft user equipment (UE) is provided. The apparatus includes: means for determining an aerial zone based on a location of the aircraft UE; means for determining a mapping of the aerial zone to at least one terrestrial zone; and means for steering a radio frequency (RF) beam to a position within the at least one terrestrial zone.

In another example, a method for wireless communications performed at network entity is provided. The method includes: determining, based on trajectory data associated with an aircraft user equipment (UE), a first mapping of one or more aerial zones to one or more terrestrial zones; receiving, from the aircraft UE, an aerial zone identifier associated with a first aerial zone from the one or more aerial zones; identifying, based on the first mapping, a first terrestrial zone from the one or more terrestrial zones that is associated with the first aerial zone; and transmitting, to the aircraft UE, a terrestrial zone identifier associated with the first terrestrial zone.

In another example, an apparatus for wireless communications performed at network entity is provided that includes at least one memory (e.g., configured to store data) and at least one processor (e.g., implemented in circuitry) coupled to the at least one memory. The at least one processor is configured to and can: determine, based on trajectory data associated with an aircraft user equipment (UE), a first mapping of one or more aerial zones to one or more terrestrial zones; receive, from the aircraft UE, an aerial zone identifier associated with a first aerial zone from the one or more aerial zones; identify, based on the first mapping, a first terrestrial zone from the one or more terrestrial zones that is associated with the first aerial zone; and transmit, to the aircraft UE, a terrestrial zone identifier associated with the first terrestrial zone.

In another example, a non-transitory computer-readable medium is provided that has stored thereon instructions that, when executed by one or more processors, cause the one or more processors to: determine, based on trajectory data associated with an aircraft user equipment (UE), a first mapping of one or more aerial zones to one or more terrestrial zones; receive, from the aircraft UE, an aerial zone identifier associated with a first aerial zone from the one or more aerial zones; identify, based on the first mapping, a first terrestrial zone from the one or more terrestrial zones that is associated with the first aerial zone; and transmit, to the aircraft UE, a terrestrial zone identifier associated with the first terrestrial zone.

In another example, an apparatus for wireless communications performed at network entity is provided. The apparatus includes: means for determining, based on trajectory data associated with an aircraft user equipment (UE), a first mapping of one or more aerial zones to one or more terrestrial zones; means for receiving, from the aircraft UE, an aerial zone identifier associated with a first aerial zone from the one or more aerial zones; means for identifying, based on the first mapping, a first terrestrial zone from the one or more terrestrial zones that is associated with the first aerial zone; and means for transmitting, to the aircraft UE, a terrestrial zone identifier associated with the first terrestrial zone.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 is a diagram illustrating an example of relay aircraft coverage mobility in a dense aircraft scenario, in accordance with some examples;

FIG. 6A is a diagram illustrating a three-dimensional (3D) aerial zone, two-dimensional (2D) terrestrial surface zone, and a relay aircraft at a first time, in accordance with some examples;

FIG. 6B is a diagram illustrating the 3D aerial zone, 2D terrestrial surface zone, and relay aircraft of FIG. 6A at a second time, in accordance with some examples;

FIG. 7A is a diagram illustrating an example of a mapping process between 3D aerial zones and 2D surface zones based on a central coordination process, in accordance with some examples;

FIG. 7B is a diagram illustrating an example of a mapping process between 3D aerial zones and 2D surface zones based on distributed coordination process, in accordance with some examples;

FIG. 8 is a diagram illustrating an example of a 3D aerial zone configuration, in accordance with some examples;

FIG. 9 is a diagram illustrating an example of a mapping between a 3D aerial zone and a 2D surface zone based on a same horizontal location, in accordance with some examples;

FIG. 10 is a diagram illustrating an example of a mapping between a 3D aerial zone and a 2D surface zone based on elevation angle, in accordance with some examples;

FIG. 11 is a flow diagram illustrating an example of a process for wireless communications performed at an aircraft user equipment (UE), in accordance with some examples; and

FIG. 12 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In some cases, a client device may be outside of the coverage area associated with a wireless communication network. For example, a client device may be located in a geographical area that is outside the range of the nearest base station or in a geographical area with poor signal quality. In some examples, a client device that is outside of the coverage area associated with a wireless communication network can also be referred to as a “remote UE.” In some cases, access to a wireless communication network may be possible by using satellite communications. However, communication with existing satellite systems (e.g., Iridium® satellites) may not be practical. For example, communication with existing satellite systems may require the use of specialized client devices that satisfy strict antenna and transmit power requirements. In some cases, use of such specialized client devices requires skillful human-assisted operation for antenna positioning in a manner that avoids interference. While the shortcomings of existing satellite systems may be addressed by 3GPP non-terrestrial networks (NTN), such networks are associated with very high deployment costs (e.g., launching of new satellites), which may delay or hinder implementation.

Air-to-ground (ATG) communications can be used to provide connectivity between terrestrial wireless communication networks and aircrafts. As used herein, an aircraft can include any apparatus or device that is configured to or able to fly through the air, such as an airplane (e.g., commercial airplanes, private airplanes, turboprop aircrafts, piston aircrafts, jets, military aircrafts, etc.), an unmanned aerial vehicle (UAE) or drone, a helicopter, an airship (e.g., a blimp or other airship), a glider, or other apparatus or device that is configured to or able to fly. For example, ATG communications can be implemented by positioning an antenna on a base station in an upward direction (e.g., antenna up-tilting) to facilitate communication with an airborne aircraft having one or more antennas on the bottom and/or sides of the aircraft fuselage. ATG communications can be used to provide in-flight passenger communication services, airline operation communications, and air traffic control services, among others. Advantages of ATG communications over satellite communications can include lower cost, higher throughput, and lower latency.

In some cases, an aircraft can be configured as a relay aircraft that can relay data between a user equipment (UE) and a network entity (e.g., a base station). Such aircraft may also be referred to as “relay aircraft.” In some cases, a given aircraft may only be able to serve as a relay aircraft for a short time due to the speed of flight of the aircraft through a relay area in which the aircraft is able to communicate with the UE and the base station (e.g., intersection between the flight route and coverage areas of the UE and/or the base station). In one illustrative example, an aircraft travelling at a speed of 250 meters (m)/second(s) through a circular relay area having a radius of 50 km would serve as a relay aircraft for 400 s. In some cases, the limited time that an aircraft may perform as a relay aircraft may not be sufficient for performing various ATG communications. For example, a UE may not receive feedback to an SOS message within the short window of time that the relay aircraft remains within range of both the UE and the base station to which the UE's SOS message is relayed by the relay aircraft.

In some examples, a relay aircraft at a cruising altitude of 10 kilometers (km) can be associated with a line-of-sight (LoS) propagation distance of 200 km or greater. When multiple relay aircraft are present in relatively close proximity to one another, a given terrestrial or surface location (e.g., the location of a remote UE) may be located within the ATG LOS propagation range of multiple different relay aircraft. For example, relay aircraft may cluster or otherwise be positioned in relatively close proximity to one another in locations such as those near airports and/or those near established air traffic routes, lanes, paths, etc. In some examples, the presence of multiple relay aircraft that are each within ATG communication range with a remote UE (e.g., within LoS propagation distance) can also be referred to as a “dense aircraft scenario.”

In the dense aircraft scenario, multiple relay aircraft may be able to provide ATG communication coverage to the same out of coverage terrestrial or surface location (e.g., multiple relay aircraft may be able to provide ATG communication coverage to the same remote UE). Based at least in part on the various trajectories, velocities, altitudes, etc., associated with the multiple relay aircraft at different times, ATG communication path switching and/or relay aircraft handover may occur frequently. The dense aircraft scenario for ATG communications between multiple relay aircraft and a remote UE may additionally be associated with a large computational overhead (e.g., in identifying available and/or optimal ATG communication paths between the remote UE and the various relay aircraft, updating the path computations at a short time interval due to the kinematics of the relay aircraft relative to the remote UE, etc.).

In some examples, the dense aircraft scenario can be associated with interference between ATG communications transmitted from the different relay aircraft to the same remote UE, which can impede or prevent successful transmission of SOS or other messages by the remote UE. In some cases, interference can occur in both a UE-initiated discovery scenario and an aircraft-initiated discovery scenario. For example, in the UE-initiated discovery scenario, multiple relay aircraft may each send feedback in response to receiving a discovery message from the remote UE; the feedback responses can cause interference at the remote UE and/or prevent the remote UE from successfully completing the discovery process. In the aircraft-initiated discovery scenario, multiple relay aircraft may each transmit or broadcast a discovery message; the discovery messages can likewise cause interference at the remote UE and/or prevent the remote UE from successfully completing the discovery process.

There is a need for systems and techniques that can be used to perform ATG communications between a remote UE and one or more relay aircraft with switching and/or handover (HO) of the relay aircraft. For example, there is a need for systems and techniques that can be used to perform ATG communications between a remote UE and relay aircrafts in a dense aircraft scenario, with reduced switching and/or handover of relay aircraft and with an improved service time of each relay aircraft beam for a given out-of-coverage zone (e.g., the location of the remote UE).

Systems, apparatuses, processes (also referred to as methods), and computer-readable media (collectively referred to as “systems and techniques”) are described herein for performing beam steering for one or more relay aircrafts used to implement air-to-ground (ATG) communications. For example, the one or more relay aircraft may be used to perform ATG communication with a remote user equipment (UE), where the remote UE is located outside of the coverage area associated with a wireless communication network and one or more relay aircrafts are used to relay a message (e.g., an SOS message) from the remote UE to a base station included in the wireless communication network. In some aspects, the systems and techniques can be used to perform beam steering for the one or more relay aircrafts to reduce the incidence of the remote UE switching ATG communication paths between different relay aircrafts and/or to reduce the incidence of handovers between different relay aircrafts. In one illustrative example, the systems and techniques can be used to perform beam steering based on a three-dimensional (3D) zone identifier associated with the current location of a relay aircraft and a two-dimensional (2D) zone identifier associated with a terrestrial surface location of the remote UE.

For example, in some aspects relay aircraft switching can be used to extend data relaying time between a user equipment (UE) and a network entity such as a base station. In some cases, relay aircraft switching can be used to avoid message loss by configuring a start time for a target relay aircraft to continue data relaying between a remote UE and a base station. In some examples, an aircraft can be configured to relay data between a remote UE and a base station while the aircraft is within a relay area. For example, the relay area can correspond to a geographic area in which the aircraft can communicate with the UE and the base station. For instance, the relay area can be based on the location and the signal range of the UE and base station. In some examples, the relay area can be a three-dimensional (3D) aerial zone (e.g., an aerial zone including a volume of space in which a relay aircraft may be present during flight, located above a terrestrial surface where a remote UE may be located).

In some aspects, relay aircraft beam steering can be performed to reduce switching and/or handover between relay aircraft used to perform (e.g., relay) ATG communications from a remote UE to a base station of a wireless communication network. In some cases, relay aircraft beam steering can additionally, or alternatively, be used to increase the service time of a given relay aircraft beam used to communicate with a remote UE (or other given out-of-coverage zone of the wireless communication network).

For example, a plurality of aerial 3D zones can be generated for a given volume of space in which aircraft (e.g., relay aircraft) may be present. Each aerial 3D zone can be associated with a different set of coordinates and/or can include a different volume of aerial space. In some aspects, an aerial 3D zone can be a cuboid shape with a length that is longer than its width/depth. In some cases, an aerial 3D zone be a cuboid shape with a horizontal square side that is larger than a vertical square side. For example, the cuboid aerial 3D zones can be oriented in the approximate direction of expected travel of relay aircraft flying through the cuboid aerial 3D zone (e.g., the greater length of the cuboid aerial 3D zone can be oriented in an expected or most probable direction of travel of relay aircraft, which travel at a higher horizontal velocity than vertical velocity.

In some examples, the plurality of aerial 3D zones can be generated using a minimum inter-aircraft distance, such that a maximum of one relay aircraft may be located in a given aerial 3D zone at any given time. In some examples, the plurality of aerial 3D zones can be generated with one or more dimensions that are greater than the minimum inter-aircraft distance, and more than one relay aircraft may simultaneously be located in the same given aerial 3D zone at a given time. In some cases, each aerial 3D zone can be associated with an aerial 3D zone identifier.

The systems and techniques can be used to perform relay aircraft beam steering based on one or more mappings between the aerial 3D zones (e.g., using the aerial 3D zone identifier) and one or more 2D terrestrial surface zones (e.g., using a terrestrial surface 2D zone identifier). For example, based on the current location of a given relay aircraft, a corresponding aerial 3D zone identifier can be determined, identifying the particular aerial 3D zone in which the relay aircraft is currently located. Based on the aerial 3D zone identifier determined for the relay aircraft current location, a terrestrial surface 2D zone identifier can be determined based on the mapping between aerial 3D zones and surface 2D zones.

In some aspects, the systems and techniques can be used to perform relay aircraft beam steering by steering, while the relay aircraft remains in its current aerial 3D zone, a communication beam associated with the relay aircraft toward the surface 2D zone mapped to the identifier of the current aerial 3D zone. In some examples, the systems and techniques can be used to reduce relay aircraft switching and/or handovers in a dense aircraft scenario in which multiple relay aircraft are located within a same aerial 3D zone and/or in which multiple relay aircraft are within LoS communication range of a remote UE. For example, within a given aerial 3D zone, a single relay aircraft can be selected and used to perform ATG communications with a remote UE. Non-selected relay aircraft located within the same given aerial 3D zone will not perform ATG communications with the remote UE, despite being within LOS range, and relay aircraft interference, switching, and handover may be reduced.

Further aspects of the systems and techniques will be described with respect to the figures.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAE) or drone, helicopter, airship, glider, etc.) and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

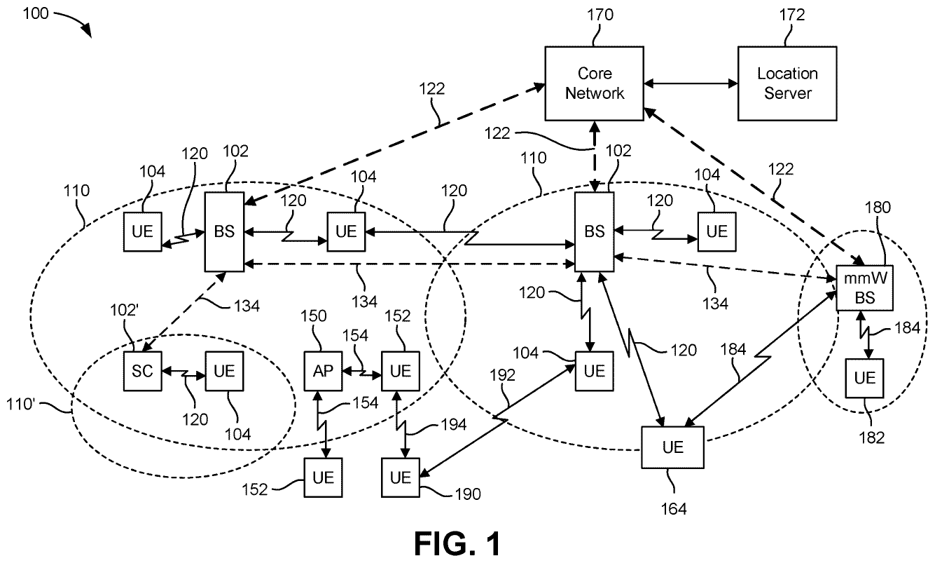

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 104 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHZ), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

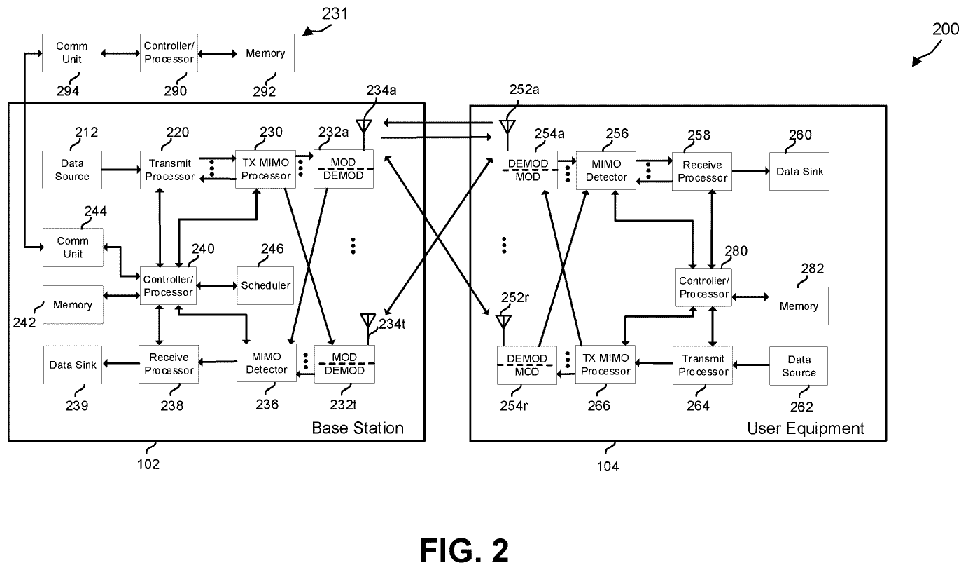

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

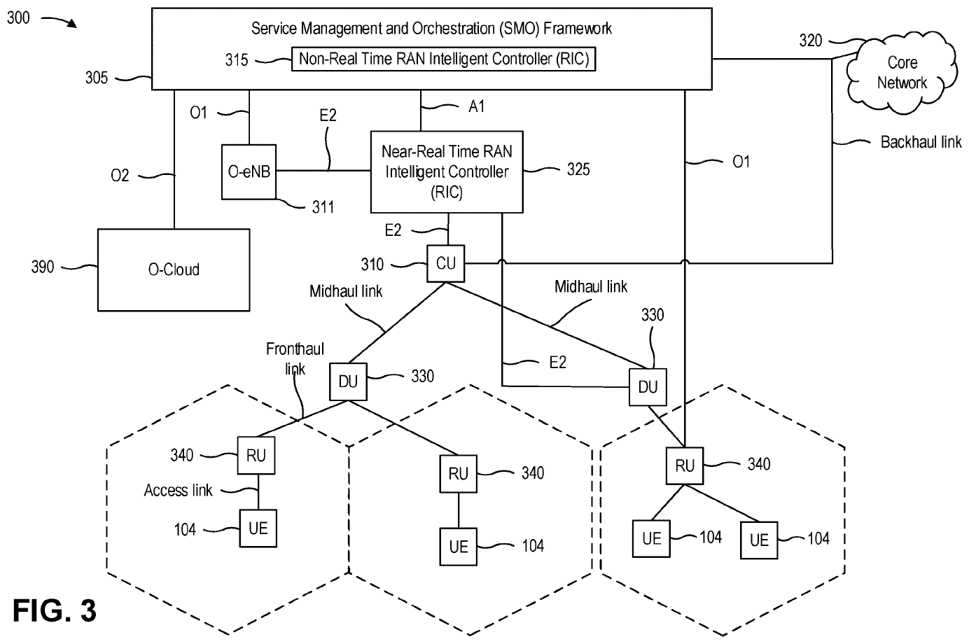

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUS 310, the DUs 330, the RUs 340, as well as the Near-RT RICs 325, the Non-RT RICs 315 and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based at least in part on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via O1) or via creation of RAN management policies (e.g., such as A1 policies).

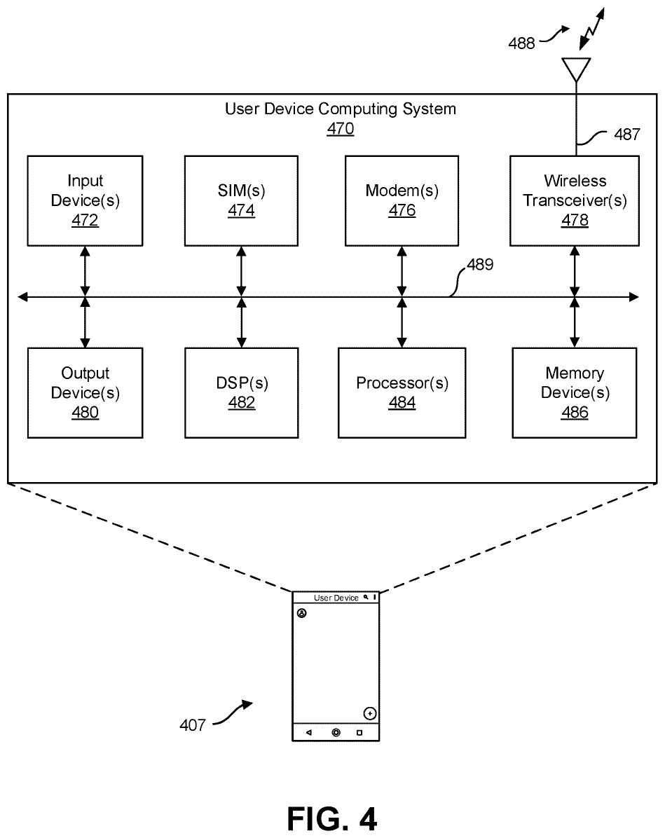

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (e.g., or may otherwise be in communication, as appropriate). For example, the computing system 470 includes one or more processors 484. The one or more processors 484 may include one or more CPUs, ASICs, FPGAS, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

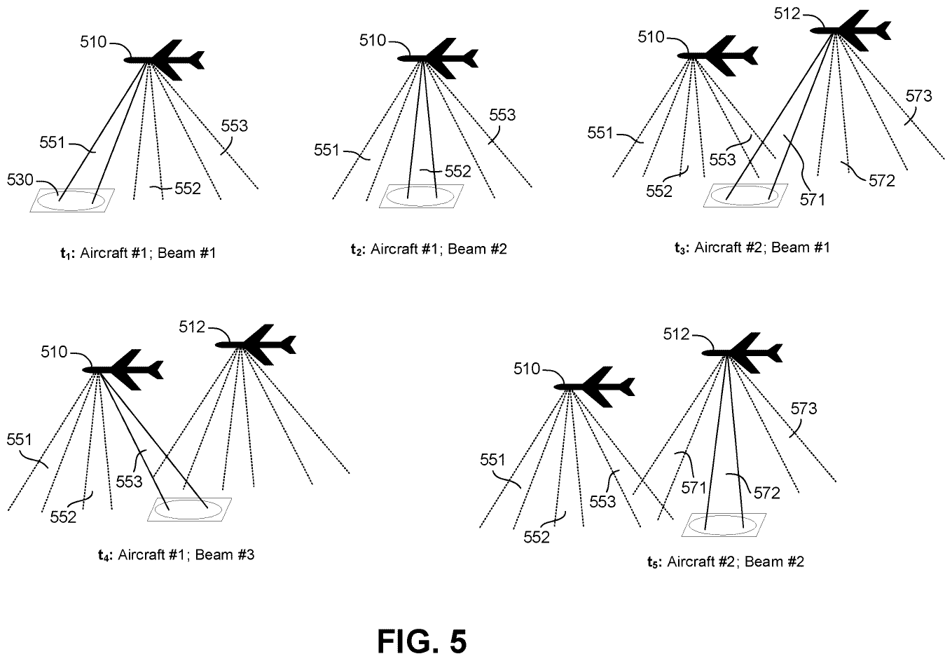

As noted previously, systems and techniques are described herein for performing beam steering for one or more relay aircrafts used to implement air-to-ground (ATG) communication. FIG. 5 is a diagram illustrating an example of relay aircraft coverage mobility in a dense aircraft scenario, in accordance with some examples. As mentioned previously, a dense aircraft scenario may occur when multiple relay aircraft are within LOS and/or ATG communication range of a remote UE or other terrestrial surface location. As will be described in greater depth below, the dense aircraft scenario may be associated with an active ATG communication beam or path being switched between different relay aircraft over time (e.g., may be associated with multiple relay aircraft handovers).

For example, FIG. 5 depicts a terrestrial surface 2D zone 530, which may be associated with a remote UE and/or an out-of-coverage area of a given wireless communication network. In some cases, the terrestrial surface 2D zone 530 (e.g., also referred to as a “2D zone”) may be a square, although other shapes may also be utilized. In one illustrative example, the 2D zone 530 can be associated with a remote UE (not shown), which may itself be associated with a transmission range that is wholly or partially included within the 2D zone 530. For example, a transmission range of a remote UE may be represented by the elliptical area depicted within the 2D zone 530 of FIG. 5.

At a first time t₁, ATG communications can be performed between the remote UE and a first relay aircraft 510, using a first beam 551 associated with first relay aircraft 510. As illustrated, the first relay aircraft 510 can be associated with multiple beams (e.g., first beam 551, a second beam 552, and a third beam 553, etc.), where each beam is oriented differently relative to first relay aircraft 510.

At a second time t₂ (e.g., subsequent to time t₁), the first relay aircraft 510 may have traveled relative to the terrestrial surface 2D zone 530 such that first beam 551 is no longer in range of the 2D zone 530, but the second beam 552 has come into range of the 2D zone 530. As illustrated in FIG. 5, at time t₂ second beam 552 becomes the active beam used to perform ATG communications between first relay aircraft 510 and the remote UE located within 2D zone 530 (e.g., as indicated by the solid line used to illustrate second beam 552 at time t₂) and first beam 551 is no longer the active beam (e., as indicated by the dashed line used to illustrate first beam 551 at time t₁).

In some examples, the presence of multiple relay aircraft that are within communication range of 2D zone 530 and/or the remote UE located in 2D zone 530 can cause the active or current ATG communication path (e.g., beam) used to relay communications from the remote UE to switch back and forth between the different relay aircraft. For example, at time t₃, first relay aircraft 510 has continued to travel along its path and second beam 552 has moved out of communication range with 2D zone 530. However, prior to third beam 553 moving into communication range with 2D zone 530, a beam of a second relay aircraft 512 may move into communication range with 2D zone 530, causing a relay aircraft switching/handover event (e.g., where a first beam 571 of second relay aircraft 512 becomes the active or current beam used for the ATG communication path with the remote UE located in the 2D zone 530).

In some cases, relay aircraft switching or handover events can be used to maintain ATG communication relay service to a remote UE when a first relay aircraft has moved out of range and a second relay aircraft comes within range. However, in a dense aircraft scenario with multiple relay aircrafts each having multiple beams, the beam pattern(s) of the relay aircrafts may cause a remote UE to cycle between beams of the same set of relay aircraft. For example, as illustrated, at time t₂ the remote UE may communicate using second beam 552 of the first relay aircraft 510. At time t₃, the remote UE may switch relay aircraft and communicate using first beam 571 of the second relay aircraft 512.

At time t₄ the remote UE may again switch relay aircraft by switching back to the first relay aircraft 510 from the second relay aircraft 512 (e.g., the remote UE switches to using third beam 553 of the first relay aircraft 510). At time t₅, the remote UE may once again switch relay aircraft, by switching back to the second relay aircraft 512 from the first relay aircraft 510 (e.g., the remote UE switches to using second beam 572 or third beam 573 of the second relay aircraft 512).

In the example described above, three relay aircraft switching events (e.g., handovers) may occur with only two relay aircraft overhead of the remote UE located at 2D zone 530. In some cases, dense aircraft scenario that include a greater number of relay aircraft and/or a greater number of beams per relay aircraft than that depicted in FIG. 5 may be associated with a greater incidence or frequency of the switching and handover events that occur back and forth between the same relay aircrafts.

In the above example of FIG. 5, the beams associated with the relay aircraft may be implemented as fixed beams (e.g., beams with a static or constant orientation relative to the relay aircraft) and/or may otherwise be implemented without performing beam steering. As mentioned previously, the systems and techniques described herein can be used to perform beam steering to reduce relay aircraft switching and handovers. In one illustrative example, a relay aircraft beam can be steered to provide continuous coverage of the same terrestrial surface 2D zone (e.g., in which a remote UE is located) while the relay aircraft is located within an aerial 3D zone associated with the terrestrial surface 2D zone.

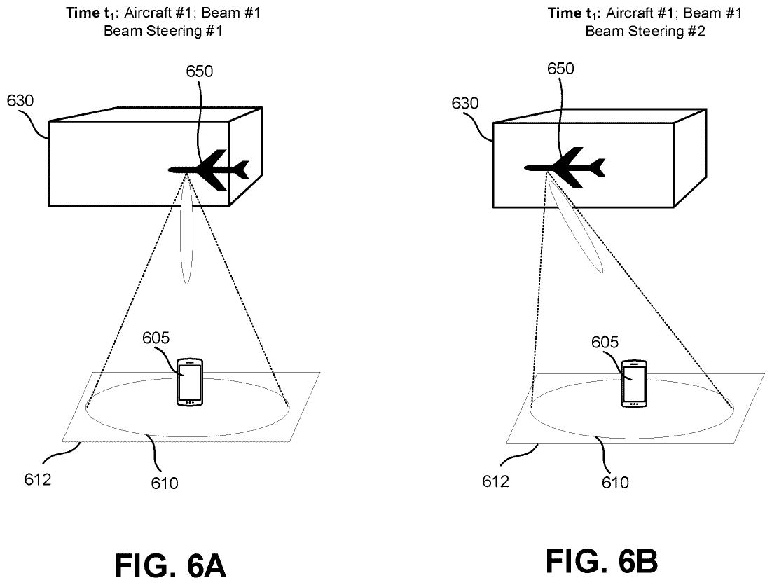

For example, FIGS. 6A and 6B are diagrams illustrating an example of beam steering performed by a relay aircraft 650 located within an aerial 3D zone 630. As illustrated, FIG. 6A depicts the orientation of the steered beam at a first time t₁ and FIG. 6B depicts the orientation of the steered beam at a second time t₂. As illustrated, relay aircraft 650 is located within the same aerial 3D zone 630 at both times t₁ and t₂, with the steered beam orientation adjusted between time t₁ and t₂ to maintain coverage of ground 2D zone 610 of a surface 612 by the steered beam.

In some aspects, beam steering can be performed to adjust the orientation of the steered beam for the duration of the time that the relay aircraft 650 is located within the aerial 3D zone 630. For example, relay aircraft 650 can steer its beam to keep the beam oriented toward the ground 2D zone 610. In examples in which a remote UE 605 is located wholly or partially within ground 2D zone 610, the steered beam of relay aircraft 650 can be used to perform ATG communications between remote UE 605 and relay aircraft 650 while the relay aircraft 650 is located within the aerial 3D zone 630.

In one illustrative example, a relay aircraft (e.g., relay aircraft 650) can perform beam steering such that a beam associated with the relay aircraft is steered toward a ground 2D zone that is mapped to the current aerial 3D zone in which the relay aircraft is located. For example, relay aircraft 650 can perform beam steering based on a mapping between ground 2D zone 610 and the relay aircraft's current aerial 3D zone 630. For example, an identifier associated with ground 2D zone 610 can be mapped to an identifier associated with aerial 3D zone 630.

In some aspects, relay aircraft 650 can use its current location to obtain a 3D zone identifier associated with the particular aerial 3D zone 630 in which the relay aircraft 650 is located. In some examples, relay aircraft 650 can locally determine the corresponding 3D zone identifier for its current location. For example, relay aircraft 650 can determine Global Positioning System (GPS) coordinates of its current location and use a local (e.g., onboard) database storing coordinates of a plurality of pre-determined aerial 3D zones to obtain an identifier of the current aerial 3D zone 630. In some cases, relay aircraft 650 can use one or more GPS receivers associated with the relay aircraft 650 (e.g., onboard GPS receivers, GPS receivers integrated with a navigation system of the aircraft UE, etc.) In some examples, the identifier of the particular aerial 3D zone associated with the current location of relay aircraft 650 can be determined remotely (e.g., based on a remote server or computing device receiving the current location of relay aircraft 650, obtaining the identifier of the corresponding aerial 3D zone 630, and transmitting the aerial 3D zone identifier (e.g., to the relay aircraft 650) in response.

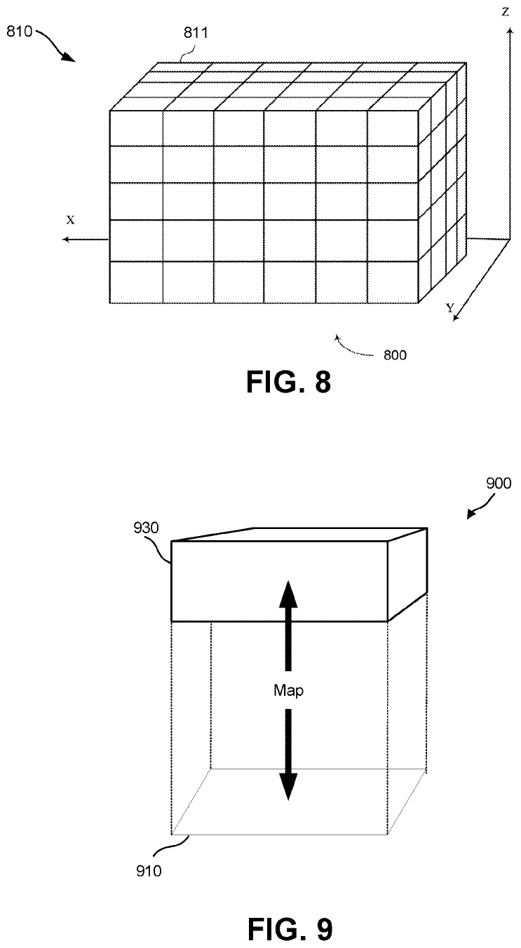

In one illustrative example, relay aircraft 650 can determine the identifier of its current aerial 3D zone locally (e.g., using its current location and a database of pre-determined aerial 3D zones, as described above). Relay aircraft 650 can subsequently obtain the mapped ground 2D zone identifier associated with the current 3D zone identifier. For example, relay aircraft 650 can transmit its current 3D zone identifier to a base station, gNB, remote computing device, and/or a network device included in a wireless communication network. The base station (e.g., gNB) can receive the current 3D zone identifier from the relay aircraft 650 and determine the corresponding ground 2D zone associated with the aerial 3D zone. For example, the base station or gNB can compare the current 3D zone identifier received from relay aircraft 650 to a database of pre-determined mappings between aerial 3D zones and ground 2D zones, as has been described previously. Aspects of the pre-determined mappings between the aerial 3D zones (e.g., aerial 3D zone 630) and the ground 2D zones (e.g., ground 2D zone 610) are further described with respect to FIGS. 8-10.

In some aspects, the systems and techniques described herein can be used to perform zone control for a plurality of aerial 3D zones and/or a plurality of relay aircraft. Zone control can be utilized to reduce or eliminate interference associated with multiple relay aircraft being located in and/or transmitting ATG communications within the same aerial 3D zone. In one illustrative example, the plurality of aerial 3D zones can be controlled such that at any given time, a maximum of one relay aircraft is enabled in a given aerial 3D zone. For example, when only one relay aircraft is enabled in an aerial 3D zone (e.g., only one aerial relay aircraft per aerial 3D zone is transmitting and receiving ATG communications with a remote UE), multi-aircraft interference is reduced or eliminated.

In one illustrative example, the systems and techniques can be used to perform zone control for a plurality of aerial 3D zones and a plurality of relay aircraft such that a given ground 2D zone is not mapped to multiple aerial 3D zones at the same time (e.g., such that multiple aerial 3D zones with relay aircraft passing by at the same time cannot be mapped to the same ground 2D zone).

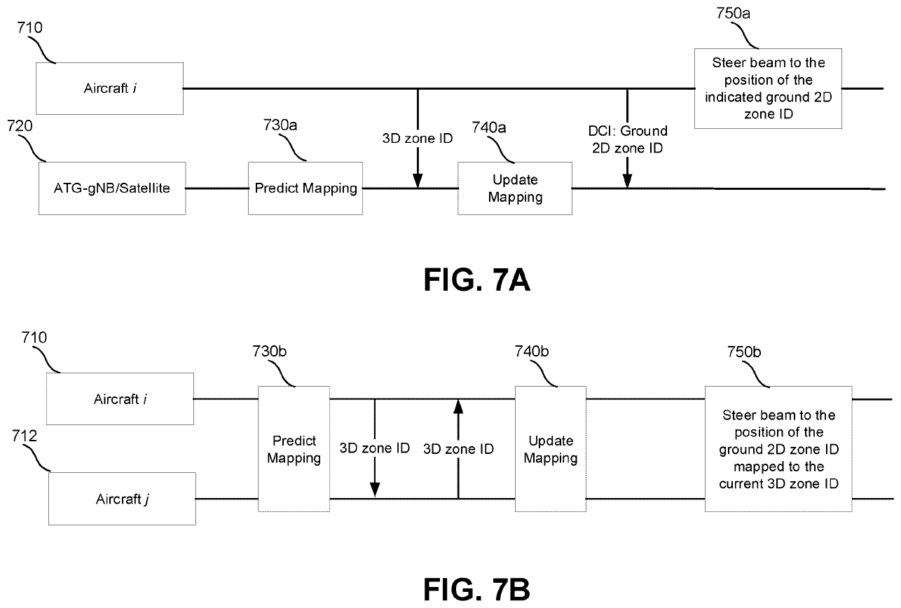

For example, FIG. 7A is a diagram illustrating an example of a semi-static mapping between 3D aerial zones and 2D ground zones that utilizes a central coordination process (FIG. 7B illustrates an example of a semi-static mapping between 3D aerial zones and 2D ground zones that utilizes a distributed coordination process). In the example of FIG. 7A, a relay aircraft 710 can transmit its current 3D zone identifier to an air-to-ground (ATG) base station 720. For example, the ATG base station 720 can be a gNB, a satellite, a remote computing device or server, a network component, etc. In one illustrative example, the same ATG base station 720 can be used to communicate with (e.g., receive current 3D zone identifiers from) multiple different relay aircraft. In some examples, a wireless communication network can include multiple ATG base stations 720 each communicating with one or more different relay aircraft.

As illustrated in the example of FIG. 7A, the ATG base station 720 can use the current 3D zone identifier received from relay aircraft 710 to determine a corresponding 2D ground zone identifier. In one illustrative example, the ATG base station 720 can generate a predicted mapping 730a for the relay aircraft 710, prior to receiving the current 3D zone identifier transmitted by the relay aircraft 710. For example, ATG base station 720 can use planned route or trajectory information associated with relay aircraft 710 to generate the predicted 2D ground zone mapping 730a for one or more discrete times (e.g., based on a prediction of the position of relay aircraft 710 along the planned route at a given discrete moment in time).

In some aspects, ATG base station 720 can update the predicted 2D ground zone mapping based on receiving the current 3D zone identifier from relay aircraft 710. For example, ATG base station can determine an updated mapping 740a based on an offset or differential between the predicted position of relay aircraft 710 along the planned route and the actual location of relay aircraft 710 as indicated by the current 3D zone identifier. In one illustrative example, ATG base station 720 can determine the updated mapping 740a in real-time (e.g., as ATG base station 720 receives an indication of the current 3D zone ID for relay aircraft 710). In some aspects, ATG base station 720 can receive the current 3D aerial zone ID from relay aircraft 710 and compare the current 3D aerial zone ID to the planned route information associated with relay aircraft 710. If the current 3D aerial zone ID and the planned route information are the same (or sufficiently similar), ATG base station 720 can transmit the predicted 2D ground zone mapping 730a to relay aircraft 710 (e.g., without determining the updated mapping 740a). As illustrated in FIG. 7A, ATG base station 720 can transmit a message (e.g., in a DCI message, a medium access control element (MAC-CE), RRC signaling, or other signaling) to relay aircraft 710 indicating the 2D ground zone ID that is associated with the current 3D aerial zone ID provided by relay aircraft 710. In one illustrative example, ATG base station 720 can provide the 2D ground zone ID in a DCI message transmitted to relay aircraft 710. In response to receiving the 2D ground zone ID (e.g., in the DCI message) from ATG base station 720, the relay aircraft 710 can steer a beam to a position of the indicated 2D ground zone ID.

FIG. 7B illustrates an example of a semi-static mapping between 3D aerial zones and 2D ground zones that utilizes a distributed coordination process between multiple relay aircraft. In the example of FIG. 7B, the distributed coordination process is depicted between a first relay aircraft 710 and a second relay aircraft 712, although it is noted that a greater number of relay aircraft may also be utilized in the distributed coordination process described below.

For example, as illustrated in FIG. 7B, each relay aircraft included in the distributed coordination process for 3D-2D zone mapping (e.g., relay aircraft 710 and relay aircraft 712) can locally predict the mapping of 3D aerial zones to 2D ground zones. For example, each relay aircraft can predict the mapping of 3D aerial zones to 2D ground zones that includes all of the relay aircraft in a nearby area (e.g., the area associated with the mapping being predicted). The local prediction of the 3D-2D zone mapping can be performed based on planned route and/or trajectory information associated with one or more (or all) of the relay aircraft. In some examples, the local prediction can additionally, or alternatively, be performed based at least in part on the most recent position information previously received for one or more (or all) of the relay aircraft. In one illustrative example, each respective relay aircraft can generate an initial mapping prediction based on the planned route and/or trajectory information associated with the relay aircraft in the mapped area. Each respective relay aircraft may subsequently update the initial mapping prediction based on one or more zone IDs (e.g., current position information) exchanged between the relay aircraft. Based on exchanging their zone IDs and/or other current position information, each respective relay aircraft may generate an updated mapping prediction based on the updated positions of the other relay aircraft.

In the example of the distributed coordination process for determining a mapping between 3D aerial zones to 2D ground zones depicted in FIG. 7B, each relay aircraft can share its current position (e.g., as a current 3D aerial zone ID) among neighboring relay aircraft. For example, relay aircraft 710 can share its current 3D aerial zone ID with relay aircraft 712, and relay aircraft 712 can share its current 3D aerial zone ID with relay aircraft 710. Based on the distribution of the current relay aircraft 3D aerial zone IDs, each relay aircraft participating in the distribution 3D-2D zone mapping process may obtain its own current 3D aerial zone ID and the current 3D aerial zone IDs for neighboring relay aircraft. Using the distributed 3D aerial zone IDs received from neighboring relay aircraft, each relay aircraft can update the locally predicted 3D-2D zone mapping 730b. In one illustrative example, a set of neighboring relay aircraft exchanging their current 3D aerial zone IDs may each converge to the same updated 3D-2D zone mapping 740b (e.g., based on each of the neighboring relay aircraft using the same set of current 3D aerial zone IDs to generate the updated 3D-2D zone mapping 740b). In some aspects, by converging to the same updated 3D-2D zone mapping 740b, a set of neighboring relay aircraft (e.g., relay aircraft 710 and 712) may reach a consensus mapping such that multiple relay aircraft and/or multiple 3D aerial zones are not simultaneously mapped to the same 2D ground zone. Based on the updated 3D-2D zone mapping 740b, the set of neighboring relay aircraft (e.g., relay aircraft 710 and 712) can each steer (e.g., at block 750b) their respective beam to the position of the 2D ground zone mapped to their respective current 3D aerial zone ID.

FIG. 8 is a diagram illustrating an example of a 3D aerial zone configuration that can be utilized to perform relay aircraft beam steering. The 3D aerial zone configuration 800 may implement aspects of the wireless communications systems as described with reference to FIGS. 1-4. For example, the 3D aerial zone configuration 800 may represent airspaces divided into a plurality of 3D zones, which may be used to indicate the geographic location information for a relay aircraft when performing beam steering based on a location of a remote UE and/or 2D ground zone as described herein.

In some aspects, the 3D aerial zone configuration 800 can include a plurality of 3D zones 810 (including 3D zone 811) that extend in three dimensions (e.g., an X dimension, a Y dimension, and a Z dimension). The 3D zones 810 may be examples of cubes or other 3D shapes. As an illustrative example, the airspace covered by the 3D aerial zone configuration 800 may be defined by dividing the airspace into 3D cubes or cuboids. The size of the 3D cubes may be configured at one or more base stations, gNBs, satellites, and/or one or more relay aircraft included in an ATG communication network. For example, the base stations and/or relay aircraft may be pre-configured with a size of the cubes, a quantity or arrangement of the cubes, locations of the cubes (e.g., where the 3D airspace begins or end), or any combination thereof.

FIG. 9 is a diagram illustrating an example of a mapping 900 between a 3D aerial zone 930 and a 2D ground zone 910 with a same or shared horizontal location. For example, a plurality of 3D aerial zones (e.g., such as the 3D zones 810 included in the example 3D aerial zone configuration 800 illustrated in FIG. 8) can be mapped to the 2D ground zone that is located directly beneath each respective one of the 3D aerial zones. In some aspects, the corresponding 2D ground zone located directly beneath a given 3D aerial zone can be determined based on the horizontal coordinate(s) of the given 3D aerial zone, with the corresponding 2D ground zone identified based on having the same (or most similar) horizontal coordinate(s) to the given 3D aerial zone.

In some aspects, the mapping of 3D aerial zones to 2D ground zones based on a common or shared horizontal location (e.g., the mapping of 3D aerial zones to the 2D ground zones directly below) can be implemented with a relatively lower computational complexity than various other mapping approaches. Based on the lower computational complexity of the common horizontal location-based mapping, such a 3D-2D zone mapping can be determined locally (e.g., onboard) by one or more relay aircraft; can be determined remotely by one or more base stations, gNBs, satellites, or other network entities; or a combination of the two. In some aspects, the 3D-2D zone mapping described above with respect to FIG. 9 can be determined in advance and provided to one or more of the relay aircraft as pre-determined data. In some examples, the 3D-2D zone mapping of FIG. 9 can be determined in substantially real-time, for example as needed during one or more of the mapping prediction processes 730a, 730b and/or the mapping update processes 740a, 740b illustrated in FIGS. 7A-7B.

In some examples, a vertical mapping of 3D aerial zones to the 2D ground zones that are directly below (e.g., a mapping based on the 3D aerial zones having a zero or minimal horizontal offset with respect to the their mapped 2D ground zones) can be associated with a low relay aircraft passing by probability (e.g., the probability of a relay aircraft passing through the 3D aerial zone mapped to a given 2D ground zone). For example, in some cases, within a 100 km cell radius defined on a terrestrial surface, 90% of aircraft (e.g., relay aircraft) may be observed between 6-18 degrees of elevation angle with respect to the ground plane.

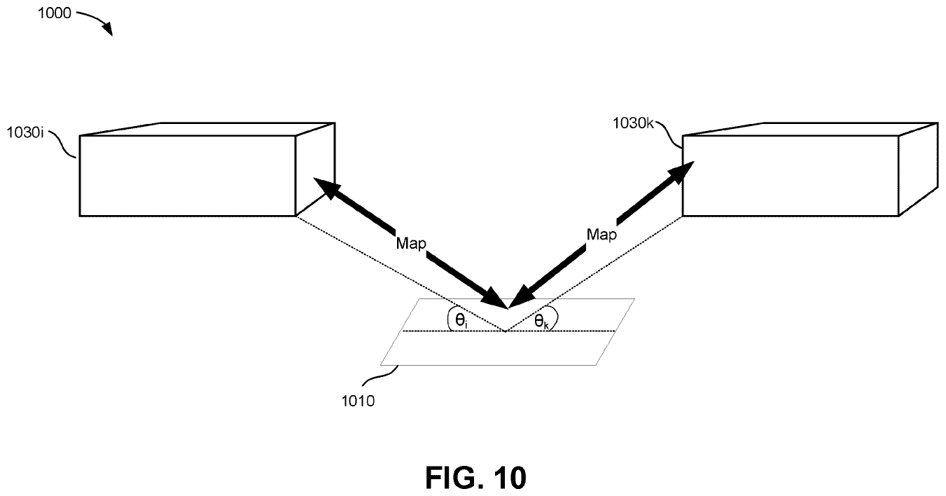

FIG. 10 is a diagram illustrating an example of a mapping 1000 between 3D aerial zones and 2D ground zones based on an elevation angle between the ground plane and each 3D aerial zone. In one illustrative example, a given 3D aerial zone can be mapped to the 2D ground zone with which the given 3D aerial zone forms a pre-determined elevation angle (or the 2D ground zone with which the given 3D aerial zone forms an elevation angle that falls within a pre-determined range of angular values). For example, a given 3D aerial zone can be mapped to the 2D ground zone with which the 3D aerial zone forms an elevation angle determined to be associated with a greatest aircraft occurrence probability. In some cases, a 3D aerial zone can be mapped to a 2D ground zone with which the 3D aerial zone forms an elevation angle between 6 and 18 degrees.

For example, a line can be extended from the plane of a given 2D ground zone 1010 to a plurality of 3D aerial zones (e.g., shown here as the 3D aerial zones 1030i and 1030k, although it is noted that a greater quantity of 3D aerial zones can be utilized or otherwise present). An elevation angle can be determined between the 2D ground zone 1010 and the each 3D aerial zone of the plurality of 3D aerial zones. For example, an elevation angle of θᵢ can be formed between the plane of 2D ground zone 1010 and a first 3D aerial zone 1030i; an elevation angle of θₖ can be formed between the plane of 2D ground zone 1010 and a second 3D aerial zone 1030k. Of the plurality of 3D aerial zones analyzed with respect to the 2D ground zone 1010, in some examples, only a single 3D aerial zones may be selected and mapped to the 2D ground zone (e.g., with the remaining 3D aerial zones being subsequently considered for mapping to other 2D ground zones, or allowed to remain unmapped to a 2D ground zone).

In some aspects, the mapping of 3D aerial zones to 2D ground zones can be performed based on determining, for a given 3D aerial zone, the 2D ground zone with which the given 3D aerial zones forms an elevation angle that increases or maximizes the aircraft occurrence probability within the 2D ground zone.

In some aspects, a set of 3D aerial zones (e.g., the plurality of 3D aerial zones 810 included in the 3D aerial zone configuration 800 illustrated in FIG. 8) may be mapped to one or more 2D ground zones that were previously identified as including an out-of-coverage area of a wireless communication network. For example, a ground surface area can be divided into a continuous grid of 2D ground zones, and 2D ground zones that are not located in an out-of-coverage area of the wireless communication network can be removed from the set. When the 3D-2D zone mapping process described herein is subsequently performed, a given 3D aerial zone may be mapped to either a 2D ground zone located in an out-of-coverage area of the wireless communication network or will not be mapped at all.

In some examples, the systems and techniques described herein for performing relay aircraft beam steering to 2D ground zones and/or remote UEs can be performed continuously while a relay aircraft is aloft (e.g., flying a planned route). In some cases, performing beam steering while a relay aircraft is not within ATG communication range with one or more out-of-coverage cells or out-of-coverage areas of a wireless communication network may be inefficient. In one illustrative example, the systems and techniques can perform relay aircraft beam steering in response to one or more beam steering triggers, as will be described in greater depth below.

In some cases, a relay aircraft can locally trigger beam steering from the relay aircrafts current 3D aerial zone to a corresponding 2D ground zone mapped to the current 3D aerial zone. For example, a relay aircraft can trigger beam steering based on a local determination that the relay aircraft has entered or will soon enter a 3D aerial zone mapped to an out-of-coverage 2D ground zone. The local determination can be made in by the relay aircraft in examples in which discovery (e.g., for the ATG communication session between a remote UE and relay aircraft) is initiated by the remote UE, in examples in which discovery is initiated by the relay aircraft, or both.

In one illustrative example, a relay aircraft can implement a location-based beam steering trigger. For example, the relay aircraft can compare its current location (e.g., GPS coordinate, GLONASS coordinate, inertial navigation coordinate, etc.) to the pre-determined location(s) of one or more out-of-coverage areas of a wireless communications network. In some aspects, the pre-determined locations of out-of-coverage areas of the wireless communications network can be provided as a general area that includes one or more out-of-coverage 2D ground zones (e.g., a relay aircraft can compare its current location to a set of one or more general areas in which beam steering is to be triggered). In some examples, the pre-determined locations of out-of-coverage areas of the wireless communications network can be the same as the locations of the out-of-coverage 2D ground zones. For example, as a relay aircraft travels along its route, the relay aircraft can determine whether each 3D aerial zone that it enters (or is about to enter) is mapped to an out-of-coverage 2D ground zone. If the relay aircraft determines it has entered, or is about to enter, a 3D aerial zone mapped to an out-of-coverage 2D ground zone, the relay aircraft can trigger beam steering. If the relay aircraft determines it has entered, or is about to enter, a 3D aerial zone that is not mapped to an out-of-coverage 2D ground zone, the relay aircraft will not perform beam steering.

In one illustrative example, a relay aircraft can implement a time-based beam steering trigger. The time-based beam steering trigger can be based at least in part on a planned route or trajectory of the relay aircraft. For example, the relay aircraft's planned route, along with planned velocity and/or other kinematic information of the flight, can be used to determine one or more times at which the relay aircraft will be within ATG communication range of one or more out-of-coverage 2D ground zones. For example, the relay aircraft's planned route and planned kinematic information can be used to generate one or more predicted locations of the relay aircraft at one or more discrete points in time. By comparing the predicted locations of the relay aircraft with one or more areas/locations in which beam steering is to be triggered, the systems and techniques can determine one or more points in time (e.g., time-based triggers) at which the relay aircraft should perform beam steering.

In some examples, a relay aircraft can be triggered to perform beam steering based on receiving one or more indication triggers from an ATG base station, such as a gNB, satellite, etc. In one illustrative example, the ATG base station can perform the location-based trigger calculations and/or the time-based trigger calculations described above and transmit a beam steering trigger to a relay aircraft based on the results of the trigger calculations performed at the ATG base station. In such examples, the beam steering trigger computational workload can be offloaded from being performed locally onboard a relay aircraft to being performed remotely at the ATG base station.

In some aspects, a relay aircraft can trigger beam steering to an out-of-coverage 2D ground zone in response to receiving a signal transmitted from a remote UE located in the out-of-coverage 2D ground zone. In some cases, a relay aircraft can trigger beam steering based on one or more signals transmitted from a remote UE in a remote-UE-initiated discovery scenario. For example, in response to receiving an ATG discovery signal transmitted by a remote UE, a relay aircraft can trigger the performance of beam steering towards the out-of-coverage 2D ground zone in which the remote UE is located (e.g., the out-of-coverage 2D ground zone from which the ATG discovery signal was transmitted).

In some aspects, a relay aircraft can trigger beam steering after the relay aircraft decodes and recognizes that a received signal is a discovery signal transmitted by a remote UE. In some examples, a relay aircraft can trigger beam steering in response to the relay aircraft measuring an RSRP, RSSI, and/or SINR value that exceeds one or more thresholds (e.g., even if decoding fails at the relay aircraft). In some aspects, a relay aircraft can trigger beam steering prior to decoding a received message.

In one illustrative example, the systems and techniques can adjust the shape(s), size(s), and/or geometry of one or more 3D aerial zones and/or 2D ground zones to enhance the performance of 3D-2D zone mapping and relay aircraft beam steering.

For example, a plurality of aerial 3D zones can be generated for a given volume of space in which aircraft (e.g., relay aircraft) may be present. Each aerial 3D zone can be associated with a different set of coordinates and/or can include a different volume of aerial space (e.g., the airspace through which relay aircraft travel). In some aspects, some (or all) of the aerial 3D zones can be a cuboid shape with a length that is longer than its width/depth. In some cases, an aerial 3D zone be a cuboid shape with a horizontal square side that is larger than a vertical square side. For example, the cuboid aerial 3D zones can be oriented in the approximate direction of expected travel of relay aircraft flying through the cuboid aerial 3D zone (e.g., the greater length of the cuboid aerial 3D zone can be oriented in an expected or most probable direction of travel of relay aircraft, which travel at a higher horizontal velocity than vertical velocity.

In some examples, the plurality of aerial 3D zones can be generated using a minimum inter-aircraft distance, such that a maximum of one relay aircraft may be located in a given aerial 3D zone at any given time. In one illustrative example, the plurality of 3D aerial zones can be generated using a minimum inter-aircraft distance of 300 m in the vertical direction and 6 km in the horizontal direction. Based on generating the 3D aerial zones to be the same size as (or smaller than) the minimum inter-aircraft separation distance, any given 3D aerial zone can include a maximum of one relay aircraft at any given time, reducing or eliminating the possibility of interference occurring due to multiple relay aircraft transmitting or performing beam steering within the same 3D aerial zone.

In some examples, the plurality of aerial 3D zones can be generated with one or more dimensions that are greater than the minimum inter-aircraft distance, and more than one relay aircraft may simultaneously be located in the same given aerial 3D zone at a given time. Aerial 3D zones that are larger than the minimum inter-aircraft separation distance can be generated with a lower 3D-2D mapping complexity (e.g., computational complexity), but may also be associated with an additional computational workload associated with an additional overhead introduced in managing the control and selection of a single relay aircraft to perform ATG communications for a 3D aerial zone that includes multiple relay aircraft simultaneously.

In still further examples, the plurality of aerial 3D zones can be generated using a semi-static geometry and/or sizing that is configured by an ATG base station (e.g., gNB or satellite) based on the planned trajectories (e.g., planned routes) and the enroute position report information associated with one or more relay aircraft. For example, an ATG base station can analyze the planned trajectories of a set of relay aircraft, along with one or more previous position reports received at the ATG base station from each relay aircraft. Based on the analysis, the ATG base station can generate dynamically sized and/or positioned 3D aerial zones such that each 3D aerial zone includes a maximum of one relay aircraft at a given time and the overall quantity of 3D aerial zones is minimized.

In some aspects, one or more 2D ground zones can be generated with a square shape. For example, the 2D ground zones can be generated with a square shape based on the TS 38.331 specification. However, in some examples, the use of square 2D ground zones can be associated with a large intersection (e.g., overlap) area between mapped 3D aerial zones and neighboring 2D ground zones. For example, when a first 3D aerial zone is mapped to a first 2D ground zone that forms an elevation angle with the first 3D aerial zone that maximizes the probability of aircraft occurrence, the 3D-2D mapping across the plurality of zones can include large amounts of overlapping areas. For example, the first 3D aerial zone may exhibit large amounts of overlap with a neighboring 3D aerial zone (e.g., a second 3D aerial zone) that is mapped to a neighboring 2D ground zone (e.g., a second 2D ground zone).

In one illustrative example, the amount of overlap in the 3D-2D zone mapping generating for a plurality of 3D aerial zone and a plurality of 2D ground zones can be reduced by generating some (or all) of the 2D ground zones using a hexagonal shape. For example, when the 2D ground zones are generated with a hexagonal shape, and 3D aerial zones are mapped to the hexagonal 2D ground zone with which the 3D aerial zone forms the elevation angle associated with maximum aircraft occurrence probability, the overlap between mapped 3D zones and neighboring 2D ground zones can be reduced. In some aspects, reducing the overlap area in the 3D-2D zone mapping can reduce the computational overhead associated with resolving conflicts in the overlap area(s) (e.g., selecting a single relay aircraft to perform beam steering to the 2D ground zone(s) associated with the overlap area, when there are multiple relay aircraft located in the overlap area)

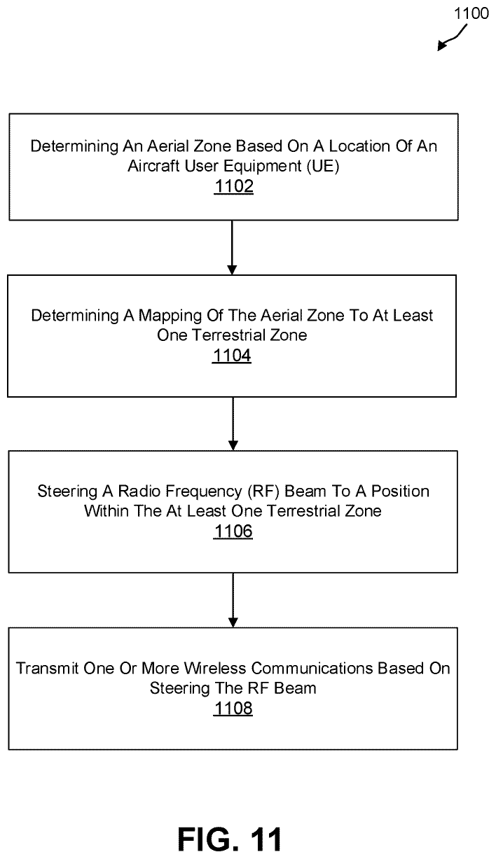

FIG. 11 is a flowchart diagram illustrating an example of a process 1100 for performing wireless communications at an aircraft user equipment (UE). At block 1102, the process 1100 includes determining an aerial zone based on a location of an aircraft user equipment (UE). For example, the aerial zone can correspond to a three-dimensional (3D) zone that encloses or includes the aircraft UE. In some examples, the aerial zone can be determined based on an aerial zone identifier (ID). In some cases, the aerial zone can be the same as or similar to one or more of the aerial zone 630 illustrated in FIGS. 6A and 6B, the aerial zone 810 illustrated in FIG. 8, the aerial zone 930 illustrated in FIG. 9, and/or the aerial zones 1030i and 1030k illustrated in FIG. 10.

In some examples, the aerial zone can correspond to a 3D zone that has a horizontal dimension that is greater than a vertical dimension. For example, the 3D zone can correspond to at least one of a cylinder, a cube, a square prism, a cuboid, and/or a hexagonal prism.

At block 1104, the process 1100 includes determining a mapping of the aerial zone to at least one terrestrial zone. For example, the terrestrial zone can correspond to a two-dimensional zone located below the three-dimensional aerial zone. In some examples, the terrestrial zone can be the same as or similar to one or more of the terrestrial zone(s) illustrated in FIG. 5, the terrestrial zone 612 illustrated in FIGS. 6A and 6B, the terrestrial zone 910 illustrated in FIG. 9, and/or the terrestrial zone 1010 illustrated in FIG. 10. In some cases, the terrestrial zone can be a two-dimensional zone that corresponds to at least one of a circle, a square, a rectangle, and/or a hexagon.

In some examples, determining the mapping of the aerial zone to the at least one terrestrial zone comprises transmitting, to a network entity, an aerial zone identifier (ID) corresponding to the aerial zone, and receiving, from the network entity, a terrestrial zone identifier corresponding to the at least one terrestrial zone. The terrestrial zone identifier can be included in downlink control information (DIC) received from the network entity. In some cases, the terrestrial zone identifier can be received from (e.g., and/or transmitted by) a base station, wherein the terrestrial zone identifier is transmitted with DCI.

In some examples, the network entity can be a base station or gNB. In some examples, the network entity is a base station or one or more of a central unit (CU), a distributed unit (DU), a remote/radio unit (RU), a Near-Real Time (Near-RT) RAN Intelligent Controller (RIC), or a Non-Real Time (Non-RT) RIC of the base station.

In some examples, the mapping of the aerial zone to the at least one terrestrial zone can be based on determining that horizontal coordinates of the aerial zone overlap with coordinates of the at least one terrestrial zone. In some examples, the mapping of the aerial zone to the at least one terrestrial zone can be based on determining that an elevation angle formed between a center of the at least one terrestrial zone and a center of the aerial zone is less than 20 degrees. For example, the elevation angle θᵢ and/or the elevation angle θₖ, both illustrated in FIG. 10, can be less than 20 degrees if the aerial zone 1030i and/or the aerial zone 1030k, respectively, are mapped to the terrestrial zone 1010.

In some examples, an aerial zone identifier can be received from a second aircraft UE, wherein the aerial zone identifier received from the second aircraft UE corresponds to a second aerial zone associated with the second aircraft UE. In some cases, the aircraft UE can adjust the mapping of the aerial zone to the at least one terrestrial zone based on the aerial zone identifier corresponding to the second aerial zone (e.g., based on the aerial zone identifier received from the second aircraft UE).

At block 1106, the process 1100 includes steering a radio frequency (RF) beam to a position within the at least one terrestrial zone. For example, steering the RF beam to the position within the at least one terrestrial zone can be based on at least one trigger. The at least one trigger can include at least one of a location trigger, a time trigger, and/or an indication trigger from a network entity.

In some examples, at least one RF signal can be received from a remote UE, and the at least one trigger can be identified based on a position of the remote UE within the at least one terrestrial zone. In some cases, at least one RF signal can be received from a remote UE, and the at least one trigger can be identified based on a threshold value of a signal measurement associated with the at least one RF signal. For example, the signal measurement can include at least one of a reference signal received power (RSRP) measurement, a reference signal received quality (RSRQ), a received signal strength indicator (RSSI) measurement, and/or a signal to interference and noise ratio (SINR) measurement.

At block 1108, the process 1100 includes transmitting one or more wireless communications based on steering the RF beam. For example, the aircraft UE can transmit one or more wireless communications using the steered RF beam. In some cases, the aircraft UE can transmit the one or more wireless communications to a remote UE. The remote UE can be located in the at least one terrestrial zone (e.g., the at least one terrestrial zone that is mapped to the aerial zone of the aircraft UE and/or the at least one terrestrial zone to which the RF beam is steered). In some examples, the one or more wireless communications can be discovery messages and/or other data messages for performing ATG relay communications between the remote UE and the aircraft UE.

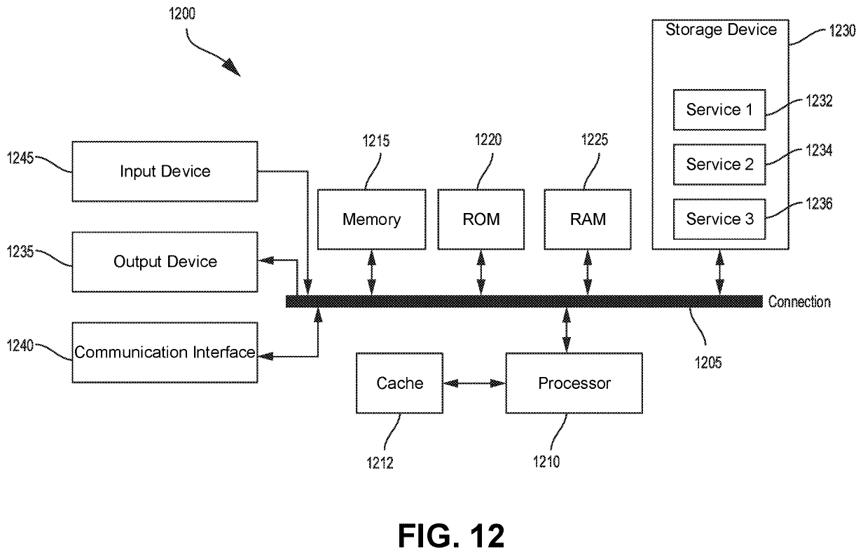

In some examples, the processes described herein (e.g., process 1100 and/or other process described herein) may be performed by a computing device or apparatus (e.g., a UE, a network entity, etc.). In one example, the process 1100 may be performed by a wireless communication device, such as a UE and/or aircraft UE (e.g., a relay aircraft). In another example, the process 1100 may be performed by a computing device with the computing system 1200 shown in FIG. 12. For instance, a wireless communication device with the computing architecture shown in FIG. 12 may include the components of the UE and may implement the operations of FIG. 11.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 1100 is illustrated as a logical flow diagram, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 1100, and/or other process described herein, may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 is a diagram illustrating an example of a system for implementing certain aspects of the present technology. In particular, FIG. 12 illustrates an example of computing system 1200, which may be for example any computing device making up internal computing system, a remote computing system, a camera, or any component thereof in which the components of the system are in communication with each other using connection 1205. Connection 1205 may be a physical connection using a bus, or a direct connection into processor 1210, such as in a chipset architecture. Connection 1205 may also be a virtual connection, networked connection, or logical connection.

In some aspects, computing system 1200 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 1200 includes at least one processing unit (CPU or processor) 1210 and connection 1205 that communicatively couples various system components including system memory 1215, such as read-only memory (ROM) 1220 and random access memory (RAM) 1225 to processor 1210. Computing system 1200 may include a cache 1212 of high-speed memory connected directly with, in close proximity to, or integrated as part of processor 1210.

Processor 1210 may include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which may represent any number of input mechanisms, such as a microphone for speech, a touch-sensitive screen for gesture or graphical input, keyboard, mouse, motion input, speech, etc. Computing system 1200 may also include output device 1235, which may be one or more of a number of output mechanisms. In some instances, multimodal systems may enable a user to provide multiple types of input/output to communicate with computing system 1200.

Computing system 1200 may include communications interface 1240, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1230 may include software services, servers, services, etc., that when the code that defines such software is executed by the processor 1210, it causes the system to perform a function. In some aspects, a hardware service that performs a particular function may include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:

Aspect 1: A method for wireless communications performed at an aircraft user equipment (UE), comprising: determining an aerial zone based on a location of the aircraft UE; determining a mapping of the aerial zone to at least one terrestrial zone; and steering a radio frequency (RF) beam to a position within the at least one terrestrial zone.

Aspect 2: The method of Aspect 1, wherein determining the mapping of the aerial zone to the at least one terrestrial zone comprises: transmitting, to a network entity, an aerial zone identifier corresponding to the aerial zone; and receiving, from the network entity, a terrestrial zone identifier corresponding to the at least one terrestrial zone.

Aspect 3: The method of Aspect 2, wherein the terrestrial zone identifier is included in downlink control information (DCI) received from the network entity.

Aspect 4: The method of any of Aspects 1 to 3, further comprising: receiving, from a second aircraft UE, an aerial zone identifier corresponding to a second aerial zone associated with the second aircraft UE; and adjusting the mapping of the aerial zone to the at least one terrestrial zone based on the aerial zone identifier corresponding to the second aerial zone.

Aspect 5: The method of any of Aspects 1 to 4, wherein horizontal coordinates of the aerial zone overlap with coordinates of the at least one terrestrial zone.

Aspect 6: The method of any of Aspects 1 to 5, wherein an elevation angle formed between a center of the at least one terrestrial zone and a center of the aerial zone is less than 20 degrees.

Aspect 7: The method of any of Aspects 1 to 6, wherein steering the RF beam to the position within the at least one terrestrial zone is based on at least one trigger.

Aspect 8: The method of Aspect 7, wherein the at least one trigger includes at least one of a location trigger, a time trigger, or an indication trigger from a network entity.

Aspect 9: The method of any of Aspects 7 to 8, further comprising: receiving at least one RF signal from a remote UE; and identifying the at least one trigger based on a position of the remote UE within the at least one terrestrial zone.

Aspect 10: The method of any of Aspects 7 to 9, further comprising: receiving at least one RF signal from a remote UE; and identifying the at least one trigger based on a threshold value of a signal measurement associated with the at least one RF signal.

Aspect 11: The method of Aspect 10, wherein the signal measurement includes at least one of a reference signal received power (RSRP) measurement, a reference signal received quality (RSRQ), a received signal strength indicator (RSSI) measurement, or a signal to interference and noise ratio (SINR) measurement.

Aspect 12: The method of any of Aspects 1 to 11, wherein the aerial zone corresponds to a three-dimensional zone and the at least one terrestrial zone corresponds to a two-dimensional zone.

Aspect 13: The method of Aspect 12, wherein three-dimensional zone has a horizontal dimension that is greater than a vertical dimension.

Aspect 14: The method of Aspect 13, wherein the three-dimensional zone corresponds to at least one of a cylinder, a cube, a square prism, a cuboid, or a hexagonal prism.

Aspect 15: The method of any of Aspects 12 to 14, wherein the two-dimensional zone corresponds to at least one of a circle, a square, a rectangle, or a hexagon.

Aspect 16: A method for wireless communications performed at network entity, comprising: determining, based on trajectory data associated with an aircraft user equipment (UE), a first mapping of one or more aerial zones to one or more terrestrial zones; receiving, from the aircraft UE, an aerial zone identifier associated with a first aerial zone from the one or more aerial zones; identifying, based on the first mapping, a first terrestrial zone from the one or more terrestrial zones that is associated with the first aerial zone; and transmitting, to the aircraft UE, a terrestrial zone identifier associated with the first terrestrial zone.

Aspect 17: The method of Aspect 16, further comprising: determining, based on the aerial zone identifier, that a current location of the aircraft UE is different than a predicted location that is based on the trajectory data; and determining, based on the current location, a second mapping of the one or more aerial zones to the one or more terrestrial zones.

Aspect 18: The method of Aspect 17, wherein the first terrestrial zone is identified based on the second mapping.

Aspect 19: The method of any of Aspects 16 to 18, wherein the terrestrial zone identifier is transmitted with downlink control information (DCI).

Aspect 20: The method of any of Aspects 16 to 19, further comprising: transmitting, to the aircraft UE, an indication to trigger radio frequency (RF) beam steering in a direction corresponding to the first terrestrial zone.

Aspect 21: The method of any of Aspects 16 to 20, wherein the network entity is a base station or one or more of a central unit (CU), a distributed unit (DU), a remote/radio unit (RU), a Near-Real Time (Near-RT) RAN Intelligent Controller (RIC), or a Non-Real Time (Non-RT) RIC of the base station.

Aspect 22: An apparatus for wireless communications performed at an aircraft user equipment (UE), comprising: at least one memory comprising instructions; and at least one processor configured to execute the instructions and cause the apparatus to: determine an aerial zone based on a location of the aircraft UE; determine a mapping of the aerial zone to at least one terrestrial zone; and steer a radio frequency (RF) beam to a position within the at least one terrestrial zone.

Aspect 23: The apparatus of Aspect 22, wherein to determine the mapping of the aerial zone to the at least one terrestrial zone, the at least one processor is configured to cause the apparatus to: transmit, to a network entity, an aerial zone identifier corresponding to the aerial zone; and receive, from the network entity, a terrestrial zone identifier corresponding to the at least one terrestrial zone.

Aspect 24: The apparatus of Aspect 23, wherein the terrestrial zone identifier is included in downlink control information (DCI) received from the network entity.

Aspect 25: The apparatus of any of Aspects 22 to 24, wherein the at least one processor is further configured to cause the apparatus to: receive, from a second aircraft UE, an aerial zone identifier corresponding to a second aerial zone associated with the second aircraft UE; and adjust the mapping of the aerial zone to the at least one terrestrial zone based on the aerial zone identifier corresponding to the second aerial zone.

Aspect 26: The apparatus of any of Aspects 22 to 25, wherein: horizontal coordinates of the aerial zone overlap with coordinates of the at least one terrestrial zone; and an elevation angle formed between a center of the at least one terrestrial zone and a center of the aerial zone is less than 20 degrees.

Aspect 27: The apparatus of any of Aspects 22 to 26, wherein: steering the RF beam to the position within the at least one terrestrial zone is based on at least one trigger; and the at least one trigger includes at least one of a location trigger, a time trigger, or an indication trigger from a network entity.

Aspect 28: The apparatus of Aspect 27, wherein the at least one processor is further configured to cause the apparatus to: receive at least one RF signal from a remote UE; and identify the at least one trigger based on a position of the remote UE within the at least one terrestrial zone or based on a threshold value of a signal measurement associated with the at least one RF signal.

Aspect 29: An apparatus for wireless communications performed at a network entity, comprising: at least one memory comprising instructions; and at least one processor configured to execute the instructions and cause the apparatus to: determine, based on trajectory data associated with an aircraft user equipment (UE), a first mapping of one or more aerial zones to one or more terrestrial zones; receive, from the aircraft UE, an aerial zone identifier associated with a first aerial zone from the one or more aerial zones; identify, based on the first mapping, a first terrestrial zone from the one or more terrestrial zones that is associated with the first aerial zone; and transmit, to the aircraft UE, a terrestrial zone identifier associated with the first terrestrial zone.

Aspect 30: The apparatus of Aspect 29, wherein the at least one processor is further configured to cause the apparatus to: determine, based on the aerial zone identifier, that a current location of the aircraft UE is different than a predicted location that is based on the trajectory data; and determine, based on the current location, a second mapping of the one or more aerial zones to the one or more terrestrial zones.

Aspect 31: An apparatus for wireless communications comprising: at least one memory; and at least one processor coupled to the at least one memory, wherein the at least one processor is configured to perform operations in accordance with any one of Aspects 1 to 15.

Aspect 32: An apparatus for wireless communications, comprising means for performing operations in accordance with any one of Aspects 1 to 15.

Aspect 33: A non-transitory computer-readable medium having stored thereon instructions that, when executed by one or more processors, cause the one or more processors to perform operations according to any one of Aspects 1 to 15.

Aspect 34: An apparatus for wireless communications comprising: at least one memory; and at least one processor coupled to the at least one memory, wherein the at least one processor is configured to perform operations in accordance with any one of Aspects 16 to 21.

Aspect 35: An apparatus for wireless communications, comprising means for performing operations in accordance with any one of Aspects 16 to 21.

Aspect 36: A non-transitory computer-readable medium having stored thereon instructions that, when executed by one or more processors, cause the one or more processors to perform operations according to any one of Aspects 16 to 21.

Aspect 37: A non-transitory computer-readable medium having stored thereon instructions that, when executed by one or more processors, cause the one or more processors to perform operations according to any one of Aspects 22 to 28.

Aspect 38: An apparatus comprising means for performing any of the operations of Aspects 22 to 28.

Aspect 39: A non-transitory computer-readable medium having stored thereon instructions that, when executed by one or more processors, cause the one or more processors to perform operations according to any one of Aspects 29 to 30.

Aspect 40: An apparatus comprising means for performing any of the operations of Aspects 29 to 30.

What is claimed is:

1. An apparatus of an aircraft user equipment (UE) for wireless communications, comprising:
at least one memory; and
at least one processor coupled to the at least one memory and configured to:
determine an aerial zone based on a location of the aircraft UE;
determine a mapping of the aerial zone to at least one terrestrial zone;
steer a radio frequency (RF) beam to a position within the at least one terrestrial zone; and
output one or more wireless communications for transmission based on steering the RF beam.

2. The apparatus of claim 1, wherein, to determine the mapping of the aerial zone to the at least one terrestrial zone, the at least one processor is configured to:
output, for transmission to a network entity, an aerial zone identifier corresponding to the aerial zone; and
receive, from the network entity, a terrestrial zone identifier corresponding to the at least one terrestrial zone.

3. The apparatus of claim 2, wherein the terrestrial zone identifier is included in downlink control information (DCI) received from the network entity.

4. The apparatus of claim 1, wherein the at least one processor is configured to:
receive, from a second aircraft UE, an aerial zone identifier corresponding to a second aerial zone associated with the second aircraft UE; and
adjust the mapping of the aerial zone to the at least one terrestrial zone based on the aerial zone identifier corresponding to the second aerial zone.

5. The apparatus of claim 1, wherein horizontal coordinates of the aerial zone overlap with coordinates of the at least one terrestrial zone.

6. The apparatus of claim 1, wherein an elevation angle formed between a center of the at least one terrestrial zone and a center of the aerial zone is less than 20 degrees.

7. The apparatus of claim 1, wherein the at least one processor is configured to steer the RF beam to the position within the at least one terrestrial zone based on at least one trigger.

8. The apparatus of claim 7, wherein the at least one trigger includes at least one of a location trigger, a time trigger, or an indication trigger from a network entity.

9. The apparatus of claim 7, wherein the at least one processor is configured to:
receive at least one RF signal from a remote UE; and
identify the at least one trigger based on a position of the remote UE within the at least one terrestrial zone.

10. The apparatus of claim 7, wherein the at least one processor is configured to:
receive at least one RF signal from a remote UE; and
identify the at least one trigger based on a threshold value of a signal measurement associated with the at least one RF signal.

11. The apparatus of claim 10, wherein the signal measurement includes at least one of a reference signal received power (RSRP) measurement, a reference signal received quality (RSRQ), a received signal strength indicator (RSSI) measurement, or a signal to interference and noise ratio (SINR) measurement.

12. The apparatus of claim 1, wherein the aerial zone corresponds to a three-dimensional zone and the at least one terrestrial zone corresponds to a two-dimensional zone.

13. The apparatus of claim 12, wherein three-dimensional zone has a horizontal dimension that is greater than a vertical dimension.

14. The apparatus of claim 13, wherein:
the three-dimensional zone corresponds to at least one of a cylinder, a cube, a square prism, a cuboid, or a hexagonal prism; and
the two-dimensional zone corresponds to at least one of a circle, a square, a rectangle, or a hexagon.

15. The apparatus of claim 1, wherein the at least one processor is configured to determine the location of the aircraft UE using a Global Positioning System (GPS) receiver associated with the aircraft UE.

16. The apparatus of claim 1, wherein the apparatus is implemented as the aircraft UE, the apparatus further comprising:
at least one transceiver configured to transmit the one or more wireless communications.

17. An apparatus of a network entity for wireless communications, comprising:
at least one memory; and
at least one processor coupled to the at least one memory and configured to:
determine, based on trajectory data associated with an aircraft user equipment (UE), a first mapping of one or more aerial zones to one or more terrestrial zones;
receive, from the aircraft UE, an aerial zone identifier associated with a first aerial zone from the one or more aerial zones;
identify, based on the first mapping, a first terrestrial zone from the one or more terrestrial zones that is associated with the first aerial zone; and
output, for transmission to the aircraft UE, a terrestrial zone identifier associated with the first terrestrial zone.

18. The apparatus of claim 17, wherein the at least one processor is configured to:
determine, based on the aerial zone identifier, that a current location of the aircraft UE is different than a predicted location that is based on the trajectory data; and
determine, based on the current location, a second mapping of the one or more aerial zones to the one or more terrestrial zones.

19. The apparatus of claim 18, wherein the first terrestrial zone is identified based on the second mapping.

20. The apparatus of claim 17, wherein the terrestrial zone identifier is transmitted with downlink control information (DCI).

21. The apparatus of claim 17, wherein the at least one processor is configured to:
output, for transmission to the aircraft UE, an indication to trigger radio frequency (RF) beam steering in a direction corresponding to the first terrestrial zone.

22. The apparatus of claim 17, wherein the network entity is a base station or one or more of a central unit (CU), a distributed unit (DU), a remote/radio unit (RU), a Near-Real Time (Near-RT) RAN Intelligent Controller (RIC), or a Non-Real Time (Non-RT) RIC of the base station.

23. The apparatus of claim 17, wherein the apparatus is implemented as the network entity, the apparatus further comprising:
at least one transceiver configured to transmit the terrestrial zone identifier.

24. A method for wireless communications at an aircraft user equipment (UE), comprising:
determining an aerial zone based on a location of the aircraft UE;
determining a mapping of the aerial zone to at least one terrestrial zone;
steering a radio frequency (RF) beam to a position within the at least one terrestrial zone; and
transmitting one or more wireless communications based on steering the RF beam.

25. The method of claim 24, wherein determining the mapping of the aerial zone to the at least one terrestrial zone includes:
transmitting, to a network entity, an aerial zone identifier corresponding to the aerial zone; and
receiving, from the network entity, a terrestrial zone identifier corresponding to the at least one terrestrial zone.

26. The method of claim 25, wherein:
the terrestrial zone identifier is included in downlink control information (DCI) received from the network entity; and
the location of the aircraft UE is determined using a Global Positioning System (GPS) receiver associated with the aircraft UE.

27. The method of claim 24, further comprising:
receiving, from a second aircraft UE, an aerial zone identifier corresponding to a second aerial zone associated with the second aircraft UE; and
adjusting the mapping of the aerial zone to the at least one terrestrial zone based on the aerial zone identifier corresponding to the second aerial zone.

28. The method of claim 24, wherein:
horizontal coordinates of the aerial zone overlap with coordinates of the at least one terrestrial zone; and
an elevation angle formed between a center of the at least one terrestrial zone and a center of the aerial zone is less than 20 degrees.

29. A method for wireless communications at a network entity, comprising:
determining, based on trajectory data associated with an aircraft user equipment (UE), a first mapping of one or more aerial zones to one or more terrestrial zones;
receiving, from the aircraft UE, an aerial zone identifier associated with a first aerial zone from the one or more aerial zones;
identifying, based on the first mapping, a first terrestrial zone from the one or more terrestrial zones that is associated with the first aerial zone; and
transmitting, to the aircraft UE, a terrestrial zone identifier associated with the first terrestrial zone.

30. The method of claim 29, further comprising:
determining, based on the aerial zone identifier, that a current location of the aircraft UE is different than a predicted location that is based on the trajectory data; and
determining, based on the current location, a second mapping of the one or more aerial zones to the one or more terrestrial zones.
